(19) United States
(12) Patent Application Publication
(10) Pub. No.: US 2008/0170500 A1
(43) Pub. Date: Jul. 17, 2008

(54) Data communication apparatus for performing bit rate control in real-time audio-video communications

(75) Inventors: Hironori Ito, Tokyo (JP); Yuzo Senda, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: NEC Corporation, Tokyo (JP)

(21) Appl. No.: 10/705,278

(22) Filed: Nov. 10, 2003

(30) Foreign Application Priority Data
Feb. 18, 2003 (JP) 2003-039642

(51) Int. Cl. G06F 15/16; H04L 1/00

(52) U.S. Cl. 370/235; 709/235; 709/250

(57) ABSTRACT

When audio and video data are transmitted in real-time over a network, a transmission bit rate is controlled depending on the congestion of the network. According to a conventional bit rate control process, the present bit rate is increased or reduced based on the difference between a target value for an amount of data and an observed value of the amount of data. Even if the network is in a steady state, the bit rate is not converged, but is continuously oscillated, tending to deteriorate the quality of transmitted audio and video data. Whereas the bit rate is controlled by only an integral circuit according to the conventional bit rate control process, a bit rate control process according to the present invention is performed using a combination of a proportional circuit and an integral circuit, making it possible to converge the bit rate and hence to prevent the quality of transmitted audio and video data from being lowered due to oscillations of the bit rate.

### BACKGROUND OF THE INVENTION

1. Field of the Invention

The present invention relates to a data communication apparatus for performing bit rate control in real-time communications to transmit audio and video data, and more particularly to a bit rate control technology for reducing congestion and utilizing a network efficiently.

2. Description of the Related Art

For transmitting audio and video data in real-time over a network, the bit rate for the transmission of the audio and video data is controlled depending on the congestion on the network. According to a conventional bit rate control process, the bit rate is controlled using a packet loss rate and a round-trip time (RTT) that are obtained from RTCP (RTP Control Protocol) used in the real-time communication protocol RTP (Real-time Transport Protocol) specified by the IETF (Internet Engineering Task Force) RFC 1889, for example.

According to the above conventional bit rate control process, the bit rate is controlled such that it is increased until the packet loss rate and the RTT exceed predetermined threshold values, respectively, and it is reduced when the packet loss rate and the RTT exceed the predetermined threshold values. Japanese laid-open patent publication No. 11-308271 discloses a bit rate control process for calculating an amount of data to be buffered in a network using an RTT and controlling the bit rate according to the following equation (1) in order to cause the amount of data to have a desired value:

Rnew=Rcur+C*(BUFdes−BUFcur) (1)

where Rnew represents a newly determined bit rate, Rcur a current bit rate, BUFdes and BUFcur a target value and a current value, respectively, for the amount of data buffered in the network, and C a suitable constant.

According to the disclosed bit rate control process, the bit rate is controlled by only an integral process which increases or reduces the present bit rate using the difference between an observed value and a target value. However, the bit rate control process based on the integral process does not only ensure stability, tending to allow the bit rate to be oscillated, rather than converged, even if the network is in a steady state. The oscillating bit rate is responsible for deteriorating the quality of audio and video data of contents that are transmitted over the network.

### SUMMARY OF THE INVENTION

It is therefore an object of the present invention to provide a data communication apparatus for performing stable bit rate control to transmit high-quality audio and video data in a real-time audio-video communication system.

A first data communication apparatus according to the present invention has means for obtaining an index representative of a state of a network, and means for controlling a bit rate according to a proportional process and an integral process on the difference between a target value for the index and an observed value of the index.

A second data communication apparatus according to the present invention resides in that in the first data communication apparatus, the index comprises an amount of data buffered in the network.

A third data communication apparatus according to the present invention resides in that the second data communication apparatus further comprises means for calculating a round-trip time over the network, and means for calculating the amount of data using the round-trip time.

A fourth data communication apparatus according to the present invention resides in that the first or second data communication apparatus further comprises means for transmitting transmission data with serial numbers assigned thereto in a sequence of the transmitted data, means for returning a reception report to which the serial numbers assigned to received data are assigned, and means for receiving the reception report and using information about data transmitted after the transmission data is transmitted until the reception report is received, as the observed value of the amount of data.

A fifth data communication apparatus according to the present invention resides in that in the fourth data communication apparatus, the information about the transmitted data comprises an amount of the transmitted data.

A sixth data communication apparatus according to the present invention resides in that any one of the first through fifth data communication apparatus is arranged for transmitting data of audio and video signals encoded in real-time at a bit rate which is controlled based on the state of the network.

A seventh data communication apparatus according to the present invention resides in that any one of the first through fifth data communication apparatus is arranged for preparing a plurality of data of audio and video signals encoded at different bit rates and transmitting the data at a bit rate determined based on the result of a bit rate control process.

An eighth data communication apparatus according to the present invention resides in that in any one of the first through seventh data communication apparatus, the means for controlling the bit rate comprises means for using, as the bit rate, the sum of a value proportional to the difference between the target value for the index and the observed value of the index, and a value produced by multiplying an integral of the difference by a constant.

The above and other objects, features, and advantages of the present invention will become apparent from the following description with reference to the accompanying drawings which illustrate an example of the present invention.

### BRIEF DESCRIPTION OF THE DRAWINGS

FIG. 1 is a block diagram of a data communication apparatus according to an embodiment of the present invention;

FIG. 2 is a block diagram of a bit rate controller in the data communication apparatus;

FIG. 3 is a block diagram showing a scheme for simulating a bit rate control process according to the present invention;

FIG. 4 is a block diagram showing a scheme for simulating a conventional bit rate control process; and

FIG. 5 is a diagram showing the results of experiments on the schemes for simulating the bit rate control process according to the present invention and the conventional bit rate control process.

### DETAILED DESCRIPTION OF THE PREFERRED EMBODIMENTS

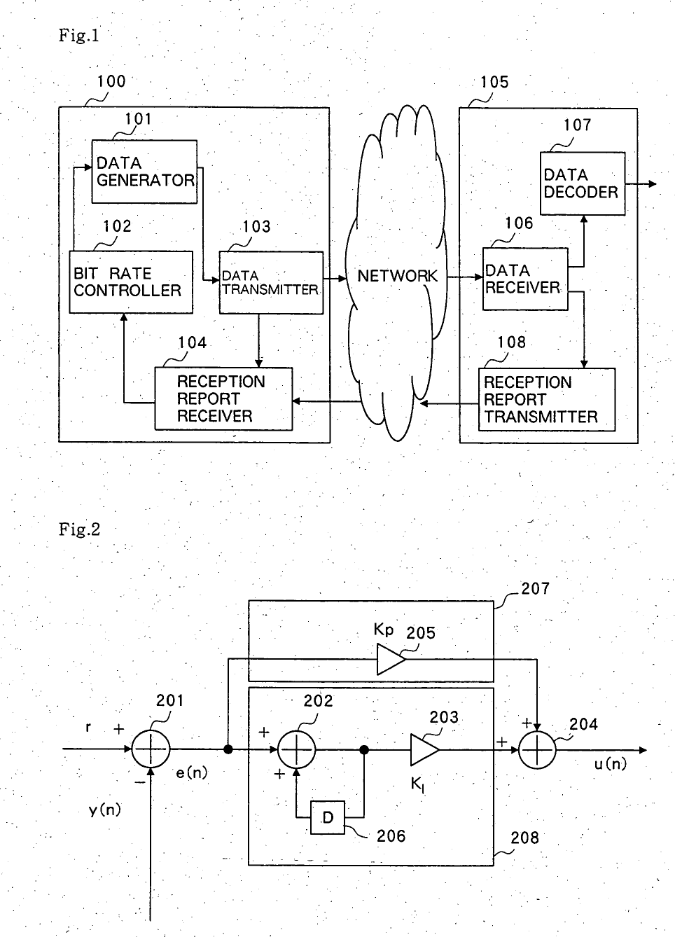

As shown in FIG. 1, a data communication apparatus according to an embodiment of the present invention comprises transmitting apparatus 100 having data generator 101, bit rate controller 102, data transmitter 103, and reception report receiver 104, and receiving apparatus 105 having data receiver 106, data decoder 107, and reception report transmitter 108.

General operation of the data communication apparatus will briefly be described below. Transmitting apparatus 100 controls a bit rate for audio data and/or video data to be transmitted at an appropriate value based on information about a network that is sent from receiving apparatus 105, and sends the controlled bit rate to receiving apparatus 105. Receiving apparatus 105 receives the audio data and/or video data transmitted from transmitting apparatus 100, decodes the received audio data and/or video data into an audio and/or video signal, and sends the information about the network to transmitting apparatus 100.

Operation of the data communication apparatus will briefly be described in detail below with reference to FIGS. 1 and 2.

First, a bit rate control process will be described below. Bit rate controller 102 calculates a bit rate for data to be transmitted to the network based on an observed value of data buffered in the network which has been obtained from reception report receiver 104, and supplies the calculated bit rate to data generator 101 and data transmitter 103.

FIG. 2 shows a detailed arrangement of bit rate controller 102. In FIG. 2, an adder 201 calculates the difference e(n) between an amount y(n) of data buffered in the network that is input at time n and a target value r. Target value r represents a value of 100000 bits, for example. The difference e(n) is supplied to proportional circuit 207 which comprises, multiplier 205 and also to integral circuit 208 which comprises adder 202, delay unit 206, and multiplier 203.

In proportional circuit 207, multiplier 205 multiplies the difference e(n) by a constant K_{P}. The product is output from proportional circuit 207 to adder 204. In integral circuit 208, the difference e(n) and a past output of adder 202 that has been delayed by delay unit 206 are input to and added by adder 202. Adder 202 outputs the sum to multiplier 203, which multiplies the sum by a constant K_{I}. The product is output from multiplier 203 to adder 204. The constants K_{P}, K_{I}, are values that determines the characteristics of the bit rate control process. For example, K_{P}=2 and K_{I}=1. Adder 204 adds the outputs from proportional circuit 207 and integral circuit 208, and outputs the sum as a bit rate u(n) at which data is to be transmitted to the network.

A process of transmitting and receiving audio and video data will be described below with reference to FIG. 1. Bit rate controller 102 inputs a determined bit rate to data generator 101. Data generator 101 generates audio and video data to be transmitted based on the bit rate determined by bit rate controller 102, and outputs the generated audio and video data to data transmitter 103. Data generator 101 operates alternatively in two modes. In one mode, data generator 101 outputs, in real-time, encoded data of audio and video signals at a given bit rate (or a value close to a given bit rate). In the other mode, data generator 101 outputs data closest to a given bit rate, of a plurality of data that have been encoded at different bit rates.

Data transmitter 103 transmits the audio and video data generated by data generator 101, at the bit rate based on which the audio and video data have been encoded, to the network. Data receiver 106 receives the audio and video data, and outputs the received audio and video data to data decoder 107. Data decoder 107 decodes the audio and video data into audio and video signals, and outputs the audio and video signals.

Processes of obtaining an amount of data buffered in the network will be described below. The processes include a process of obtaining a buffered amount of data based on the product of an RTT and the bit rate at which the data have been transmitted to the network, and a process of measuring an amount of data transmitted until a reception report on a transmitted packet is obtained.

First, the process of obtaining a buffered amount of data based on the product of an RTT and the bit rate at which the data have been transmitted to the network will be described below. An RTT may be obtained by a process according to the IETF RFC 1889 referred to above. First, data transmitter 103 in transmitting apparatus 100 transmits a transmission report where the present time is described as a transmission report transmission time Ts through the network to receiving apparatus 105.

When data receiver 106 in receiving apparatus 105 receives the transmission report, it sends the transmission report to reception report transmitter 108. Reception report transmitter 108 then sends a reception report which describes the time Tₛ described in the received transmission report and a time period Tm that is consumed after the transmission report is received until the reception report is transmitted, through the network to transmitting apparatus 100.

In transmitting apparatus 100, reception report receiver 104 calculates an RTT according to the equation (2) shown below, using a time Tᵣ when the reception report is received and the time Tₛ and the time period Tₘ described in the reception report. Reception report receiver 104 also obtains the bit rate at which the data has been transmitted to the network from the reception of a preceding reception report up to the present time, from data transmitter 103, and supplies the product of the obtained bit rate and the calculated RTT as an observed value of the amount of data buffered in the network, to bit rate controller 102.

RTT=Tₛ−Tₘ−Tᵣ (2)

An interval of time at which the transmission report and the reception report are transmitted is adjusted to about 5% of the bit rate of the audio and video data such that those transmission and reception reports will not pose an excessive burden on the network.

The process of measuring an amount of data transmitted until a reception report on a transmitted packet is obtained will be described below. When data transmitter 103 in transmitting apparatus 100 transmits audio and video data, data transmitter 103 assigns inherent serial numbers (sequence numbers) to respective, packets and sends them to the network, and also outputs the sequence numbers and the transmitted amount of data to reception report receiver 104. Data receiver 106 in receiving apparatus 105 outputs the sequence numbers assigned to the received data to reception report transmitter 108.

Reception report transmitter 108 transmits a reception report to which the input sequence numbers are assigned to the network. Reception report receiver 104 in transmitting apparatus 100 outputs the total amount of data transmitted by data transmitter 103 from the sequence numbers assigned to the reception report up to the latest sequence number, to bit rate controller 102.

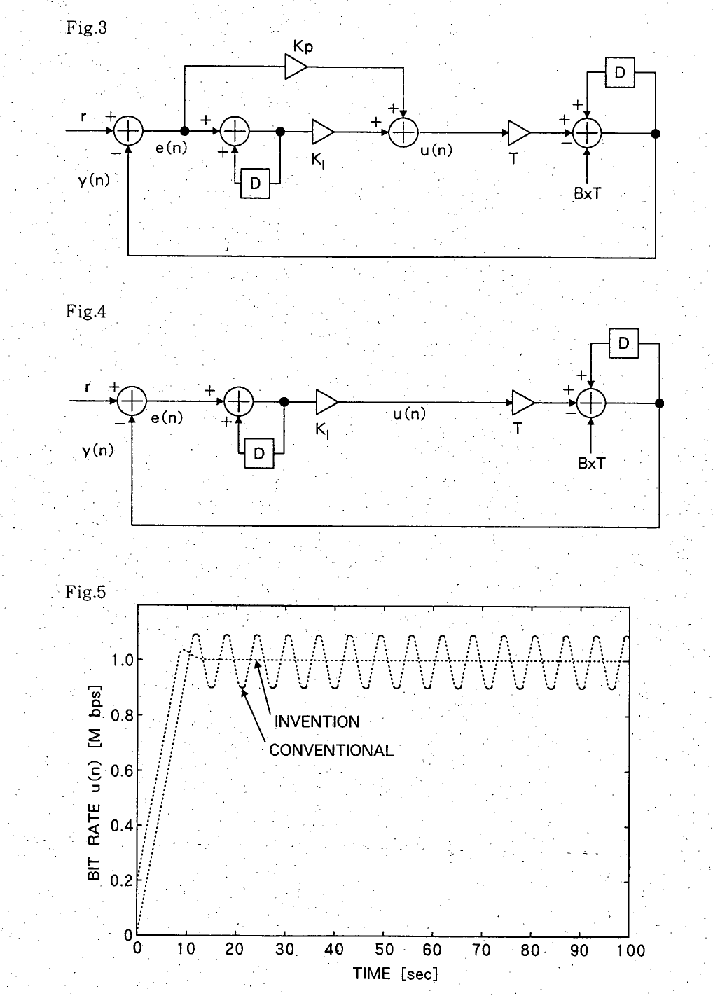

Details of bit rate controller 102 will be described below. FIG. 3 shows in block form a scheme for simulating the bit rate control process according to the present invention at discrete time intervals T in a network having a band Bbps. FIG. 4 shows in block form a scheme for simulating a conventional bit rate control process. As can be seen from FIG. 4, the conventional bit rate control process lacks a proportional process. U_{PI}(z), U_{I}(z) representing Z-transforms of a bit rate u(n) in FIGS. 3 and 4 are expressed by the following equations (3), (4), respectively:

U_{PI}(z)={(1−z)K_{P}·r−(1−z)K_{P}·B·T+(B·T−r(1−z))K_{I}}/{(1−z)²−(1−z)K_{P}+K_{I}} (3)

U_{I}(z)=K_{I}(B−(1−z)r)/{(1−z)²+K_{I}} (4)

The poles of the equation (4) are expressed by:

z=1±√(K_{I}) (5)

and are present necessarily outside of the unit circle. Therefore, the conventional bit rate control process does riot ensure bit rate control stability. In the equation (5), √(K_{I}) represents the square root of K_{I}. According to the equation (3), the double poles are present within the unit circle if K_{P}, K_{I} are set to satisfy the condition represented by the equation (6) shown below. Therefore, the bit rate control process according to the present invention ensures bit rate control stability.

K_{P}²−4K_{I}=0, 0<K_{P}≦2 (6)

Advantages of the present invention will be described below based on the results of experiments on the simulating schemes shown in FIGS. 3 and 4. The experiments were conducted on the simulating schemes under the following conditions:

T=0.001 sec., B=1 Mbps, KP=2, KI=1

FIG. 5 shows the experimental results which indicate that whereas the bit rate is oscillating according to the conventional bit rate control process, the bit rate is converged by the bit rate control process according to the present invention.

According to the present invention, since the bit rate is controlled in view of the proportional process and the integral process that are effected on the difference between the observed value and the target value, the bit rate is prevented from oscillating. Accordingly, audio and video data are prevented from suffering a quality reduction due to bit rate oscillations in real-time audio and video communications. Because the bit rate is converged, the load on the network is stabilized. Consequently, the data communication apparatus according to the present invention is effective for use in general data communications.

While a preferred embodiment of the present invention has been described using specific terms, such description is for illustrative purposes only, and it is to be understood that changes and variations may be made without departing from the spirit or scope of the following claims.

What is claimed is:

1. A data communication apparatus comprising:
means for obtaining an index representative of a state of a network; and
means for controlling a bit rate according to a proportional process and an integral process on the difference between a target value for said index and an observed value of said index.

2. A data communication apparatus according to claim 1, wherein said index comprises an amount of data buffered in said network.

3. A data communication apparatus according to claim 2, further comprising:
means for calculating a round-trip time over said network; and
means for calculating said amount of data using said round-trip time.

4. A data communication apparatus according to claim 1, further comprising:
means for transmitting transmission data with serial numbers assigned thereto in a sequence of the transmitted data;
means for returning a reception report to which the serial numbers assigned to received data are assigned; and
means for receiving said reception report and using information about data transmitted after said transmission data is transmitted until said reception report is received, as said observed value of said amount of data.

5. A data communication apparatus according to claim 2, further comprising:
means for transmitting transmission data with serial numbers assigned thereto in a sequence of the transmitted data;
means for returning a reception report to which the serial numbers assigned to received data are assigned; and
means for receiving said reception report and using information about data transmitted after said transmission data is transmitted until said reception report is received, as said observed value of said amount of data.

6. A data communication apparatus according to claim 4, wherein said information about the transmitted data comprises an amount of the transmitted data.

7. A data communication apparatus according to claim 5, wherein said information about the transmitted data comprises an amount of the transmitted data.

8. A data communication apparatus according to claim 1, for transmitting data of audio and video signals encoded in real-time at a bit rate which is controlled based on the state of the network.

9. A data communication apparatus according to claim 2, for transmitting data of audio and video signals encoded in real-time at a bit rate which is controlled based on the state of the network.

10. A data communication apparatus according to claim 3, for transmitting data of audio and video signals encoded in real-time at a bit rate which is controlled based on the state of the network.

11. A data communication apparatus according to claim 4, for transmitting data of audio and video signals encoded in real-time at a bit rate which is controlled based on the state of the network.

12. A data communication apparatus according to claim 1, for preparing a plurality of data of audio and video signals encoded at different bit rates and transmitting said data at a bit rate determined based on the result of a bit rate control process.

13. A data communication apparatus according to claim 2, for preparing a plurality of data of audio and video signals encoded at different bit rates and transmitting said data at a bit rate determined based on the result of a bit rate control process.

14. A data communication apparatus according to claim 3, for preparing a plurality of data of audio and video signals encoded at different bit rates and transmitting said data at a bit rate determined based on the result of a bit rate control process.

15. A data communication apparatus according to claim 4, for preparing a plurality of data of audio and video signals encoded at different bit rates and transmitting said data at a bit rate determined based on the result of a bit rate control process.

16. A data communication apparatus according to claim 1, wherein said means for controlling the bit rate comprises means for using, as said bit rate, the sum of a value proportional to the difference between the target value for said index and the observed value of said index, and a value produced by multiplying an integral of said difference by a constant.

17. A data communication apparatus according to claim 2, wherein said means for controlling the bit rate comprises means for using, as said bit rate, the sum of a value proportional to the difference between the target value for said index and the observed value of said index, and a value produced by multiplying an integral of said difference by a constant.

18. A data communication apparatus according to claim 3, wherein said means for controlling the bit rate comprises means for using, as said bit rate, the sum of a value proportional to the difference between the target value for said index and the observed value of said index, and a value produced by multiplying an integral of said difference by a constant.

19. A data communication apparatus according to claim 4, wherein said means for controlling the bit rate comprises means for using, as said bit rate, the sum of a value proportional to the difference between the target value for said index and the observed value of said index, and a value produced by multiplying an integral of said difference by a constant.
